(19) United States
(12) Patent Application Publication
(10) Pub. No.: US 2016/0236665 A1
(43) Pub. Date: Aug. 18, 2016

(54) ELECTRONIC BRAKE SYSTEM AND METHOD FOR CONTROLLING THE SAME

(71) Applicant: MANDO CORPORATION, Gyeonggi-do (KR)

(72) Inventors: Young Jin PARK, Gyeonggi-do (KR); Jin Ho PARK, Gyeonggi-do (KR); Kyu Woong CHOI, Gyeonggi-do (KR); Yoo Don JUNG, Gyeonggi-do (KR)

(73) Assignee: MANDO CORPORATION, Gyeonnggi-do (KR)

(21) Appl. No.: 15/018,706

(22) Filed: Feb. 8, 2016

(30) Foreign Application Priority Data
Feb. 13, 2015 (KR) 10-2015-0022305

(51) Int. Cl. B60T 13/74; B60T 15/02; B60T 8/40; B60T 7/04

(52) U.S. Cl. CPC B60T 13/741; B60T 7/042; B60T 15/028; B60T 8/4081

(57) ABSTRACT

An electronic brake system according to the present invention includes a reservoir that stores oil, a cylinder that receives supply of oil from the reservoir, a piston that is provided so as to be moved forward and backward within the cylinder, a spring that is provided within the cylinder and provides an elastic reaction force to the piston, a motor that generates a rotational force for driving the piston in accordance with an electrical signal of a pedal displacement sensor, a ball screw that converts a rotational motion of the motor into a linear motion to drive the piston, and an ECU (electronic control unit) that controls the motor. Here, a normally closed type solenoid valve that is closed in a normal state and opened when an open signal is applied from the ECU may be provided on the hydraulic line connecting the reservoir and the cylinder.

### CROSS-REFERENCE TO RELATED APPLICATION

This application claims priority to and the benefit of Korean Patent Application No. 200______-______, filed on ______ ______, 200______, the disclosure of which is incorporated herein by reference in its entirety.

### BACKGROUND

1. Field of the Invention

The present invention relates to an electronic brake system of a vehicle and, more particularly, to an electronic brake system for drag reduction which may help achieve increased fuel efficiency for the vehicle by solving a drag problem that may occur when a piston for generating a braking force is not completely returned to its original position after a pedal is released in an electronic braking system.

2. Discussion of Related Art

In recent years, the development of a hybrid vehicle, a fuel cell vehicle, an electric vehicle, and the like has been actively conducted in order to improve fuel efficiency and reduce exhaust gas. In such a vehicle, it is essential that a brake system, that is, a vehicle brake is installed. Here, the vehicle brake refers to an apparatus that functions to stop or reduce the speed of a running vehicle.

An electro-hydraulic brake which is one kind of hydraulic brakes is a brake system in which a control unit detects a driver stepping on a pedal and supplies hydraulic pressure to a master cylinder and thereby transmits brake hydraulic pressure to the wheel cylinder of each wheel and generates a braking force.

FIG. 1 is a hydraulic circuit diagram schematically showing a configuration of the above-described conventional electronic brake system for a vehicle.

Referring to FIG. 1, the conventional electronic brake system for the vehicle typically includes a master cylinder 20 that generates a fluid pressure in accordance with a stepping force on a brake pedal 10, wheel cylinders 40 that receive the fluid pressure generated by the master cylinder 20 and perform braking of each of the wheels RR, RL, FR, and FL, and a pedal displacement sensor 11 that detects a displacement of the brake pedal 10.

In addition, the conventional electronic brake system for the vehicle includes a pressure supply device that is operated by receiving a driver's braking intension as an electrical signal from the pedal displacement sensor 11, a hydraulic control unit 60 that performs braking of wheels using a force generated by the pressure supply device, first and second switching valves 62 and 64 that are connected in series to a flow passage for connecting the pressure supply device and the hydraulic control unit 60, and a simulator 70 that is connected to the master cylinder 20 to provide a reaction force to the brake pedal 10.

The pressure supply device 50 includes a pressure chamber 51 in which a predetermined space is formed so that oil is received and stored therein, a piston 52 and a spring 53 which are provided inside the pressure chamber 51, a motor 54 that generates a rotational force by the electrical signal of the pedal displacement sensor 11, a motion conversion unit 55 that converts the rotational motion of the motor 54 into a linear motion thereof, and a hydraulic flow passage 56 that connects a reservoir 57 and the pressure chamber 51 so as to supply oil to the pressure chamber 51. Here, the signal detected by the pedal displacement sensor 11 is transmitted to an ECU (electronic control unit, not shown), and the ECU controls the motor 54 and valves provided in the brake system.

As for the operation of the pressure supply device in the above-described conventional electronic brake system, the motor 54 is operated when a driver steps on the brake pedal 10 in an early phase of braking, and the motion conversion unit 55 converts the rotational force of the motor 54 into the linear motion and thereby pressure the pressure chamber 51. In this case, the pressure chamber 51 may be connected to the reservoir 57 by the hydraulic flow passage 56 so that oil is provided in a stored state, and fluid pressure may be generated in accordance with the linear motion of the motion conversion unit 55 for converting the rotational motion into the linear motion. In this instance, a check valve 58 for preventing a backflow of the pressure of the pressure chamber 51 is provided in the hydraulic flow passage 56. Such a check valve 58 functions to allow oil to be suctioned into the pressure chamber 51 and stored therein when the piston 52 is returned as well as functioning to prevent the backflow of the pressure of the pressure chamber 51.

However, when the stepping force is applied to the brake pedal 10 so that the pressure supply device is operated and then the stepping force applied to the brake pedal 10 is released, the piston 52 is returned to its original position by a repulsive force of the spring 53, but in this case, a problem of drag occurs in which the piston 52 is not completely returned to its original position.

Such a drag phenomenon is a phenomenon that occurs when a return movement of the piston 52 is blocked because the inside of the hydraulic system is not configured as a completely closed circuit due to characteristics of the check valve 58 provided on the hydraulic flow passage 56 for connecting the pressure chamber 51 and the reservoir 57, so that a problem where a residual drag torque produced by such a drag phenomenon acts as a resistance that hinders the driving of the vehicle and therefore acts an important reason the fuel efficiency is reduced.

### PRIOR ART DOCUMENT

### Patent Document

### Korea Patent Publication No. 2013-0037874 (Apr. 17, 2013)

### SUMMARY OF THE INVENTION

The present invention is directed to an electronic brake system for drag reduction, in which a normally closed type solenoid valve may be provided on a hydraulic line connecting a cylinder of a pressure supply device for supplying fluid pressure for braking and a reservoir in the electronic brake system so that a hydraulic system may be implemented as a completely closed circuit system, and therefore a piston within the cylinder may be completely returned to the original position even when a brake pedal is released, thereby improving fuel efficiency of the vehicle.

According to an aspect of the present invention, there is provided a method for controlling an electronic brake system including a pressure supply device that includes a motor, a cylinder, and a piston that is installed so as to be moved forward and backward within the cylinder based on driving of the motor, a reservoir that supplies oil to the cylinder or receives a supply of oil from the cylinder, and a solenoid valve that is disposed on a hydraulic line formed between the reservoir and the cylinder, the method including: an ECU (electronic control unit) determining whether a pressure of a wheel cylinder of a vehicle needs to be reduced; the ECU controlling the motor so that the piston is movable backward within the cylinder based on information about whether the pressure of the wheel cylinder needs to be reduced; and the ECU applying a control signal for the solenoid valve to the solenoid valve.

Here, the electronic brake system may further include a pedal displacement sensor that detects a pedal operation of a driver, and whether the pressure of the wheel cylinder needs to be reduced is determined based on a variation of a pedal stroke detected by the pedal displacement sensor.

Also, the solenoid valve may be a normally closed type solenoid valve, and the ECU applying the control signal for the solenoid valve to the solenoid valve may include the ECU applying an open signal to the solenoid valve.

Also, after the ECU applying the control signal for the solenoid valve to the solenoid valve, the method for controlling the electronic brake system may further include: the ECU determining whether the piston is completely moved back within the cylinder based on a detection result of a rotation angle sensor for detecting a rotation angle of the motor; and the ECU controlling the motor to prevent the piston from being moved backward anymore.

According to another aspect of the present invention, there is provided an electronic brake system including: a motor that is driven based on a displacement of a pedal; a pressure supply device that includes a cylinder and a piston that is provided so as to be moved forward and backward within the cylinder based on driving of the motor; a reservoir that supplies oil to the cylinder or receives supply of oil from the cylinder; a solenoid valve that is disposed on a hydraulic line formed between the reservoir and the cylinder; and an ECU that controls the motor and the solenoid valve.

Here, another hydraulic line that is branched from the hydraulic line connecting the reservoir and the cylinder and connected to the cylinder may be further provided.

Also, the hydraulic lines and may be respectively connected to a portion of the cylinder at a front side of the piston and a portion of the cylinder at a rear side thereof.

Also, the solenoid valve may be a normally closed type solenoid valve.

Also, the ECU may apply an open signal to the solenoid valve based on information about whether pressure of a wheel cylinder of a vehicle needs to be reduced.

Also, the electronic brake system may further include a pedal displacement sensor that detects a pedal operation of a driver, wherein the ECU may determine whether the pressure of the wheel cylinder needs to be reduced based on a variation of a pedal stroke detected by the pedal displacement sensor.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a hydraulic circuit diagram showing a configuration of a conventional electronic brake system for a vehicle;

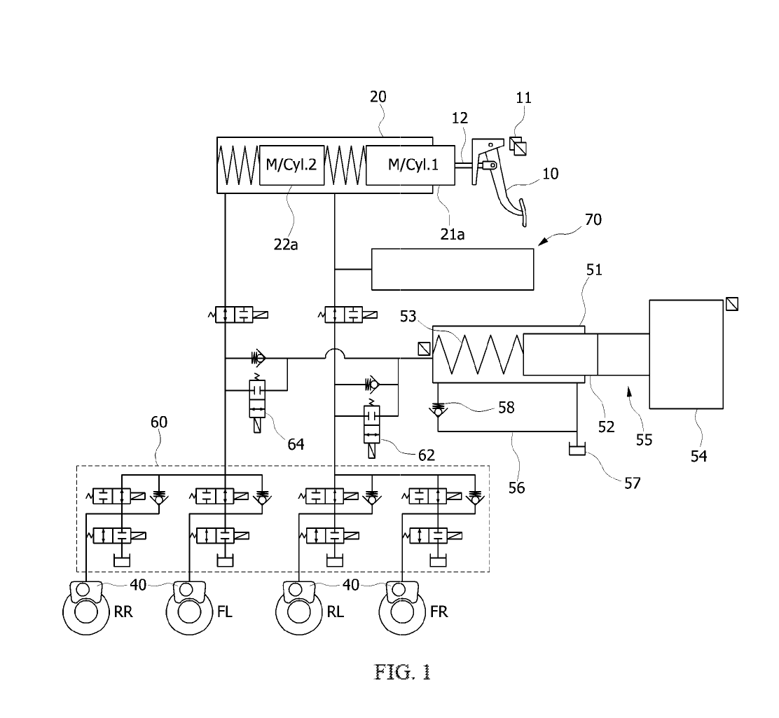

FIG. 2 is a hydraulic circuit diagram showing an electronic brake system for a vehicle according to an embodiment of the present invention; and

FIG. 3 is a flowchart chronologically showing a method for controlling an electronic brake system for a vehicle according to an embodiment of the present invention.

### DETAILED DESCRIPTION OF EXEMPLARY EMBODIMENTS

Hereinafter, preferred embodiments of the present invention will be described in detail with reference to the accompanying drawings.

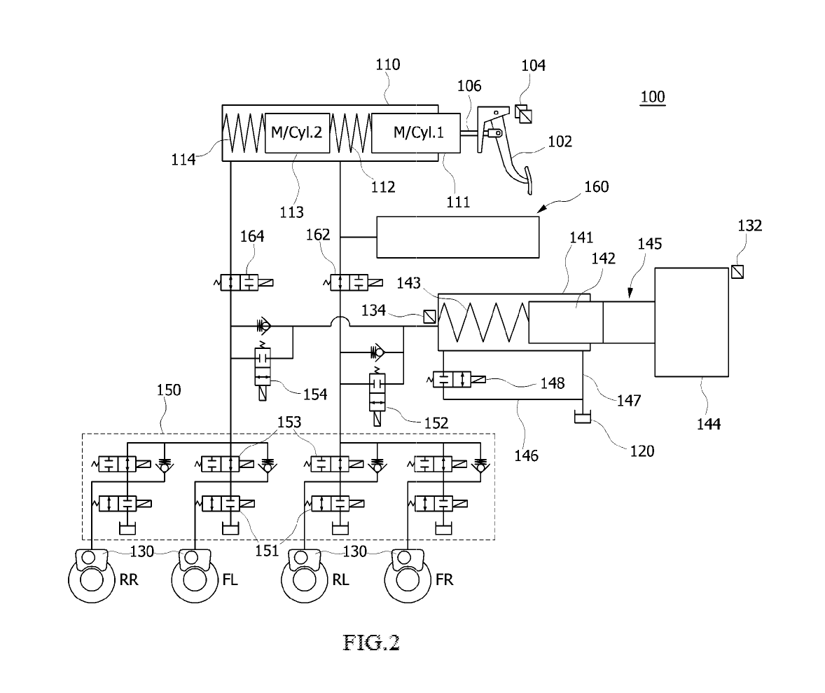

FIG. 2 is a hydraulic circuit diagram showing an electronic brake system for a vehicle for reducing a brake drag according to the present invention.

Referring to FIG. 2, the electronic brake system 100 for the vehicle for reducing a brake drag according to an embodiment of the present invention includes a master cylinder 110 that generates fluid pressure for braking of wheels, a reservoir 120 that is coupled to an upper portion of the master cylinder 110 and stores oil, an input rod 106 that presses the master cylinder 110 in accordance with a stepping force on a brake pedal 102, a wheel cylinder 130 that performs braking of each of the wheels RR, RL, FR, and FL by receiving a supply of the oil of the reservoir 120, and a pedal displacement sensor 104 that detects a displacement of the brake pedal 102.

In the master cylinder 110, a first piston 111 and a second piston 113 are formed to have two hydraulic circuits and brought into contact with the input rod 106. In this instance, one circuit of the two hydraulic circuits is connected to a front right (FR) wheel and a rear left (RL) wheel of the vehicle, and the other circuit is connected to a front left (FL) wheel and a rear right (RR) wheel of the vehicle. The reason the two circuits are independently configured in such a manner is to make braking of the vehicle possible even during a failure of one circuit.

The first piston 111 and the second piston 113 of the master cylinder 110 are elastically supported by a first spring 112 and a second spring 114. When the first piston 111 and the second piston 113 are moved forward, the elastic forces of the first spring 112 and the second spring 114 are stored due to compression.

Meanwhile, the electronic brake system 100 according to the present invention includes a pressure supply device 140 that is operated by receiving a driver's braking intension as an electrical signal from the pedal displacement sensor 104 for detecting a displacement of the brake pedal 102, a hydraulic control unit 150 that performs braking of wheels using a force generated by the pressure supply device 140, first and second switching valves 152 and 154 that are connected in series to a flow passage for connecting the pressure supply device 140 and the hydraulic control unit 150, and a pedal simulator 160 that is connected to the master cylinder 110 and provides a reaction force to the brake pedal 102.

The pressure supply device 140 includes a cylinder 141 in which a predetermined space is formed so that oil is supplied from the reservoir 120 and stored therein, a piston 142 that is provided inside the cylinder 141 so as to be moved forward and backward, a spring 143 that provides an elastic reaction force to the piston 142, a motor 144 that generates a rotational force for driving of the piston 142 by the electrical signal of the pedal displacement sensor 104, a motion conversion unit 145 that converts a rotational motion of the motor 144 into a linear motion, and a hydraulic line that connects the reservoir 120 and the cylinder 141 to supply oil to the cylinder 141.

Here, the signal detected by the pedal displacement sensor 104 is transmitted to an ECU (electronic control unit, not shown), and the ECU controls the motor 144 and valves provided in the brake system according to the present invention which will be described later.

As described above, the cylinder 141 is connected to the reservoir 120 by the hydraulic line 146 and stores supplied oil. In such a cylinder 141, the piston 142 and the spring 143 for elastically supporting the piston 142 are provided. The piston 142 is connected to the motion conversion unit 145 so that the rotational motion of the motor 144 is converted into the linear motion by the motion conversion unit 145 to press the cylinder 141, and the spring 143 takes on the role of returning the piston 142 to the original position.

When the motor 144 generates the rotational force due to a signal output from the ECU, the rotational force is generated by the ECU in a forward direction or a reverse direction. The rotational force generated by the motor 144 is converted into the linear motion by the motion conversion unit 145 to pressure the piston 142, and thereby a fluid pressure may be generated.

In addition, a normally closed type solenoid valve 148 is provided on the hydraulic line 146 that connects the cylinder 141 and the reservoir 120. Such a normally closed type solenoid valve 148 is closed in a normal state and opened when an open signal is applied from the ECU, thereby forming a flow passage between the cylinder 141 and the reservoir 120.

Here, another hydraulic line 147 that is branched from the hydraulic line 146 is provided in the hydraulic line 146 connecting the cylinder 141 and the reservoir 120 so as to be connected to the cylinder 141.

In this instance, the hydraulic lines 146 and 147 are configured to be respectively connected to a portion of the cylinder 141 at the front side of the piston 142 and a portion of the cylinder at the rear side thereof.

In this manner, the hydraulic lines 146 and 147 are formed so as to be respectively connected to the reservoir 120 at the front and rear sides of the cylinder 141, and the normally closed type solenoid valve 148 is provided on the hydraulic line 146 connected to the portion of the cylinder 141 at the front side of the piston 142, so that when the piston 142 moves forward and a pressure is added, the solenoid valve 148 may close the hydraulic line 146 so that a fluid pressure is normally generated.

Next, when the pressure on the brake pedal 102 is released so that the piston 142 moves backward, the solenoid valve 148 is opened in accordance with the open signal input from the ECU so that the flow passage connecting the cylinder 141 and the reservoir 120 form a completely closed circuit. Accordingly, the flow is maintained in a freely movable state, and therefore the piston 142 within the cylinder 141 may be completely returned to the original position with only the elastic repulsive force of the spring 143.

Meanwhile, non-described reference numerals 132 and 134 are respectively a rotation angle sensor that detects a rotation angle of the motor 144 and a pressure sensor that detects fluid pressure of the cylinder 141.

The hydraulic control unit 150 is constituted by two wheel braking circuits for receiving a supply of the fluid pressure so that braking is performed. The wheel cylinder 130 is provided in each of the wheels FR, FL, RR, and RL, and receives the supply of the fluid pressure so that braking is performed. At this point, a plurality of solenoid valves 151 and 153 for controlling fluid pressure are provided in the flow passage connected to the wheel cylinder 130. Such opening/closing operations of the solenoid valves 151 and 153 are controlled by the ECU.

In addition, the first and second switching valves 152 and 154 which are connected in series to the flow passage connecting the pressure supply device 140 and the hydraulic control unit and control transmission of the fluid pressure to the wheel cylinder 130 by opening/closing operations of the switching valves 152 and 154 are provided in the flow passage connecting the pressure supply device 140 and the hydraulic control unit. The opening/closing operations of the first and second switching valves 152 and 154 are controlled by the ECU.

Two backup flow passages for forming a flow passage are formed between the master cylinder 110 and the wheel cylinder 130, and shut-off valves 162 and 164 for opening and closing the backup flow passages are respectively provided in the backup flow passages. At this point, the backup flow passage is shut off by the shut-off valves 162 and 164 during braking of a vehicle by a driver. Also, the pedal simulator 160 for providing a reaction force in accordance with the stepping force on the brake pedal 102 is connected to the master cylinder 110.

Hereinafter, operations of the electronic brake system according to the present invention will be described in detail.

Referring to FIG. 2, when braking starts by a driver, the electronic brake system detects a required braking level of the driver by information including the pressure on the brake pedal 102 with which the driver steps using the pedal displacement sensor 104 and the like. At this point, the ECU (not shown) drives the motor 144 by receiving an electrical signal output from the pedal displacement sensor 104.

In addition, a rotational force in accordance with the driving of the motor 144 is converted into a linear motion by the motion conversion unit 145 to press the cylinder 141. At this point, the normally closed type solenoid valve 148 provided in the hydraulic line 146 between the cylinder 141 and reservoir 120 is maintained in a closed state, and the piston 142 is pressed in accordance with the linear motion of the motion conversion unit 145 for converting the rotational motion of the motor 144 into the linear motion, and thereby a fluid pressure is generated.

In addition, the shut-off valves 162 and 164 provided in the backup flow passage connected to an outlet of the master cylinder 110 are closed, so that an oil pressure generated in the master cylinder 110 is prevented from being transmitted to the wheel cylinder 130. Thus, the fluid pressure generated from the cylinder 141 is transmitted to each wheel cylinder 130 through the first and second switching valves 151 and 153 so that braking of the wheel is achieved.

Meanwhile, when braking of the wheel is achieved and then the pressure on the brake pedal 102 is released, the piston 142 within the cylinder 141 in the pressure supply device is moved backward and returned to the original position by the elastic repulsive force of the compressed spring 143. At this point, the normally closed type solenoid valve 148 is opened by the open signal applied by the ECU so that the hydraulic line 146 between the cylinder 141 and the reservoir 120 is opened.

Then, the hydraulic lines 146 and 147 each connected to the reservoir 120 at the front and rear sides of the cylinder 141 are all opened so that the flow passage connecting the cylinder 141 and the reservoir 120 forms a completely closed circuit. Accordingly, the flow is maintained in a freely movable state, and therefore the piston 142 within the cylinder 141 easily achieves a complete return to the original position by the elastic repulsive force of the spring 143 and a circulation force of the flow in accordance with the elastic repulsive force.

In this manner, the normally closed type solenoid valve 148 instead of an existing check valve is provided in the hydraulic line 146 connecting the cylinder 141 and the reservoir 120 so that the brake system is implemented as a completely closed circuit, and therefore a complete return of the piston 142 may be achieved and a thereby improved fuel efficiency of the vehicle due to reduced occurrence of drag may be expected.

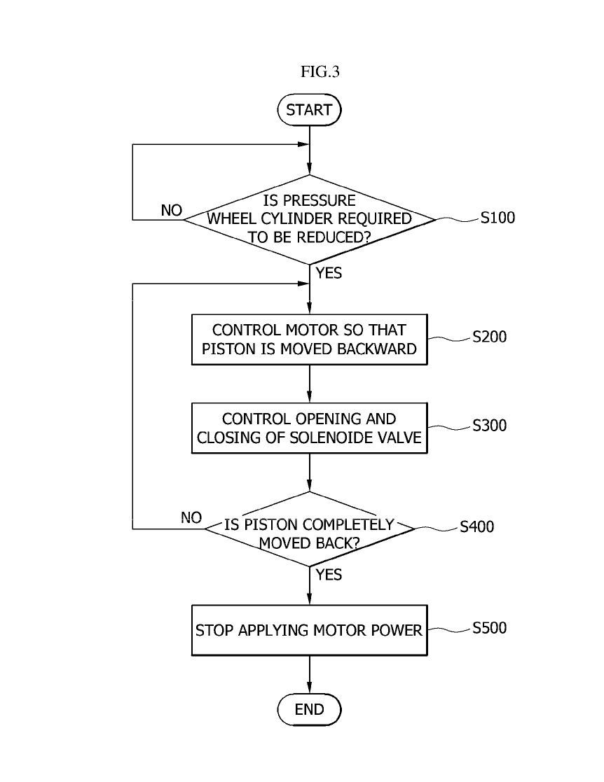

Hereinafter, a method for controlling the electronic brake system according to the present invention will be described with reference to FIG. 3. FIG. 3 is a flowchart chronologically showing a method for controlling an electronic brake system for a vehicle according to the present invention.

The method for controlling the electronic brake system according to the present invention relates to the above-described method applied to the electronic brake system according to the present invention, wherein operation S100 in which the ECU determines whether the pressure of the wheel cylinder 130 of the vehicle is required to be reduced is first performed as shown in FIG. 3. The ECU determines whether the pressure of the wheel cylinder 130 is required to be reduced based on a variation of a pedal stroke detected by the pedal displacement sensor 104. Specifically, when a driver applies a pressure to the pedal and then removes from the pedal, a displacement of the pedal is changed, and the ECU determines that the pressure of the wheel cylinder 130 needs to be reduced based on the variation.

When the ECU determines that the pressure of the wheel cylinder 130 needs to be reduced, operation S200 is performed in which the ECU controls the motor 144 so that the piston 142 can be moved backward within the cylinder 141.

Next, operation S300 is performed in which the ECU applies to the solenoid valve 148 a control signal for the solenoid valve 148 disposed on the hydraulic line formed between the reservoir 120 and the cylinder 141. Specifically, the ECU applies the open signal to the solenoid valve 148.

In this case, the flow passage connecting the cylinder 141 and the reservoir 120 forms a completely closed circuit, so that the flow is maintained in a freely movable state, and therefore the piston 142 within the cylinder 141 may be completely returned to the original position with only the elastic repulsive force of the spring 143.

Meanwhile, the method for controlling the electronic brake system according to the present invention may further include operation S400 in which the ECU determines whether the piston 142 is completely moved backward within the cylinder 141 and operation S500 in which the ECU controls the motor 144 to prevent the piston 142 from being moved backward anymore, after the operation of applying to the solenoid valve 148 the control signal for the solenoid valve 148.

Specifically, when the motor 144 applies power to cause the piston 142 to be continuously moved backward even though the piston 142 is completely moved back within the cylinder 14, an overloading is exerted on the motor 144, and therefore operations S400 and S500 are performed to prevent a damage of the motor 144 and unnecessary power consumption caused by the overload. Meanwhile, it is preferable that the ECU determines whether the piston 142 is completely moved back within the cylinder 141 based on the detection result of a rotation angle sensor for detecting the rotation angle of the motor 144.

As described above, according to the electronic brake system according to the present invention having the above-described configuration, the normally closed type solenoid valve that is closed in a normal state and opened when the open signal is applied from the ECU instead of the conventional check valve may be provided on the hydraulic line connecting the cylinder of the pressure supply device for supplying a fluid pressure for braking to the wheel cylinder and the reservoir, so that the electronic brake system may be implemented as a completely closed circuit, and therefore the piston may be completely returned to the original position within the cylinder when the brake pedal is released, and thus, a thereby normal brake operation may be performed wherein an improved fuel efficiency due to the reduced brake drag may be expected.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for controlling an electronic brake system including a pressure supply device that includes a motor, a cylinder, and a piston that is installed so as to be moved forward and backward within the cylinder based on driving of the motor, a reservoir that supplies oil to the cylinder or receives a supply of oil from the cylinder, and a solenoid valve that is disposed on a hydraulic line formed between the reservoir and the cylinder, the method comprising:
an ECU (electronic control unit) determining whether a pressure of a wheel cylinder of a vehicle needs to be reduced;
the ECU controlling the motor so that the piston is movable backward within the cylinder based on information about whether the pressure of the wheel cylinder needs to be reduced; and
the ECU applying a control signal for the solenoid valve to the solenoid valve.

2. The method for controlling the electronic brake system of claim 1, wherein the electronic brake system further includes a pedal displacement sensor that detects a pedal operation of a driver, and whether the pressure of the wheel cylinder needs to be reduced is determined based on a variation of a pedal stroke detected by the pedal displacement sensor.

3. The method for controlling the electronic brake system of claim 1, wherein the solenoid valve is a normally closed type solenoid valve, and the ECU applying the control signal for the solenoid valve to the solenoid valve includes the ECU applying an open signal to the solenoid valve.

4. The method for controlling the electronic brake system of claim 1, after the ECU applying the control signal for the solenoid valve to the solenoid valve, further comprising:
the ECU determining whether the piston is completely moved back within the cylinder based on a detection result of a rotation angle sensor for detecting a rotation angle of the motor; and
the ECU controlling the motor to prevent the piston from being moved backward anymore.

5. An electronic brake system comprising:
a motor that is driven based on a displacement of a pedal;
a pressure supply device that includes a cylinder and a piston that is provided so as to be moved forward and backward within the cylinder based on driving of the motor;
a reservoir that supplies oil to the cylinder or receives a supply of oil from the cylinder;
a solenoid valve that is disposed on a hydraulic line formed between the reservoir and the cylinder; and
an ECU that controls the motor and the solenoid valve.

6. The electronic brake system of claim 5, wherein another hydraulic line that is branched from the hydraulic line connecting the reservoir and the cylinder and connected to the cylinder is further provided.

7. The electronic brake system of claim 6, wherein the hydraulic lines and are respectively connected to a portion of the cylinder at a front side of the piston and a portion of the cylinder at a rear side thereof.

8. The electronic brake system of claim 5, wherein the solenoid valve is a normally closed type solenoid valve.

9. The electronic brake system of claim 8, wherein the ECU applies an open signal to the solenoid valve based on information about whether a pressure of a wheel cylinder of a vehicle needs to be reduced.

10. The electronic brake system of claim 9, further comprising:
a pedal displacement sensor that detects a pedal operation of a driver,
wherein the ECU determines whether the pressure of the wheel cylinder needs to be reduced based on a variation of a pedal stroke detected by the pedal displacement sensor.
